(19) United States
(12) Patent Application Publication
(10) Pub. No.: US 2007/0161720 A1
(43) Pub. Date: Jul. 12, 2007

(54) Polishing Pad with Surface Roughness

(75) Inventor: Timothy J. Donohue, Menlo Park, CA (US)

Correspondence Address: FISH & RICHARDSON P.C., P.O. BOX 1022, MINNEAPOLIS, MN, 55440-1022, US

(73) Assignee: APPLIED MATERIALS, INC., Santa Clara, CA (US)

(21) Appl. No.: 11/562,375

(22) Filed: Nov. 21, 2006

Related U.S. Application Data
(60) Provisional application No. 60/741,417, filed on Nov. 30, 2005.

(51) Int. Cl. C08G 18/00

(52) U.S. Cl. 521/172

(57) ABSTRACT

A polishing pad has a polishing layer having a polishing surface with a surface roughness between about 200 and 300 microinches. The polishing pad can be made by forming a polishing layer by extrusion or molding, and grinding a polishing surface of the polishing layer to a surface roughness between about 200 and 300 microinches.

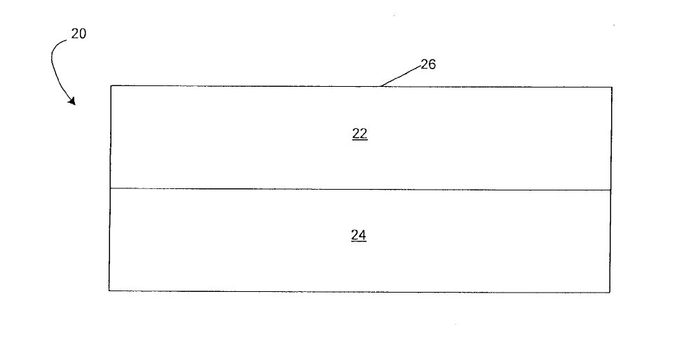

### CROSS-REFERENCE TO RELATED APPLICATIONS

This application claims priority to U.S. application Ser. No. 60/741,417, filed on Nov. 30, 2005.

### BACKGROUND

This present invention relates to polishing pads used in chemical mechanical polishing.

An integrated circuit is typically formed on a substrate by the sequential deposition of conductive, semiconductive or insulative layers on a silicon wafer. One fabrication step involves depositing a filler layer over a non-planar surface, and planarizing the filler layer until the non-planar surface is exposed. For example, a conductive filler layer can be deposited on a patterned insulative layer to fill the trenches or holes in the insulative layer. The filler layer is then polished until the raised pattern of the insulative layer is exposed. After planarization, the portions of the conductive layer remaining between the raised pattern of the insulative layer form vias, plugs and lines that provide conductive paths between thin film circuits on the substrate. In addition, planarization is needed to planarize the substrate surface for photolithography.

Chemical mechanical polishing (CMP) is one accepted method of planarization. This planarization method typically requires that the substrate be mounted on a carrier or polishing head. The exposed surface of the substrate is placed against the polishing surface of a polishing pad, such as a rotating polishing disk or linearly advancing belt. The carrier head provides a controllable load on the substrate to push it against the polishing pad. A polishing liquid, which can include abrasive particles, is supplied to the surface of the polishing pad, and the relative motion between the substrate and polishing pad results in planarization and polishing.

One objective of a chemical mechanical polishing process is to achieve wafer to wafer polishing uniformity. If different substrates are polished at different rates, it becomes difficult to achieve a uniform target layer thickness between multiple wafers. Another objective of a chemical mechanical polishing process is to achieve within wafer polishing uniformity. If different areas on the substrate are polished at different rates, then it is possible for some areas of the substrate to have too much material removed (“overpolishing”) or too little material removed (“underpolishing”), which can result in non-uniform topography across the substrate.

### SUMMARY

In one aspect, the invention is directed to a polishing pad that has a polishing layer having a polishing surface with a surface roughness between about 200 and 300 microinches.

Implementations of the invention may include one or more of the following features. The polishing surface may have a surface roughness between about 250 and 300 microinches. A backing layer may be on a side of the polishing layer opposite the polishing surface. The polishing layer may include polyurethane with voids. The polishing surface may be a fresh surface.

In one aspect, the invention is directed to a method of making a polishing pad that includes forming a polishing layer by extrusion or molding and grinding a polishing surface of the polishing layer to a surface roughness between about 200 and 300 microinches.

Implementations of the invention may include one or more of the following features. Grinding the polishing surface may include grinding the polishing surface to a surface roughness between about 250 and 300 microinches. A backing layer may be attached to a side of the polishing layer opposite the polishing surface. The polishing layer may include polyurethane with voids. The grinding step may be performed at a machine other than a polishing machine used for polishing substrates. The polishing pad may be used to polish a substrate after the grinding step. Grinding the polishing surface may include a first grinding step and second grinding step with a finer grit than the first grinding step. Forming the polishing layer may include cutting the polishing layer to a desired shape, forming the polishing layer as a sheet on a conveyor belt, or injection molding.

The details of one or more embodiments of the invention are set forth in the accompanying drawings and the description below. Other features, objects, and advantages of the invention will be apparent from the description and drawings, and from the claims.

### BRIEF DESCRIPTION OF THE DRAWING

The FIGURE is a schematic cross-sectional side view illustrating a polishing pad.

### DETAILED DESCRIPTION

Referring to the FIGURE, a polishing pad 20 can include covering or polishing layer 22 with a durable rough polishing surface 26 and a compressible backing layer 24. The backing layer 24 should be more compressible than the polishing layer 22. In one implementation, the polishing pad has a thinner covering layer and a thicker backing layer. In another implementation, the backing layer has about the same thickness as the covering layer. In yet another implementation, the polishing pad does not include a backing layer.

The polishing layer 22 can be formed of a durable polymer, such a polyurethane. The polishing layer 22 can include voids. For example, the polishing layer can be a foamed polyurethane with a closed-cell structure but substantially without other fillers such as abrasives or hollow microspheres. Grooving may be formed on the polishing surface 26 of the polishing layer 22.

The polishing surface 26 of the polishing layer 22 can have a surface roughness (Ra) equal to or greater than (but generally not by more than an order of magnitude) 200 microinches. For example, the polishing layer 22 can have a surface roughness (Ra) between 200-300 microinches, e.g., 250-300 microinches. An initial surface roughness in this range appears to provide process stability for both initial pad use and over the lifetime of the pad, such that wafer-to-wafer polishing uniformity appears to stay relatively stable over the lifetime of the pad. The polishing pad may be useable immediately for polishing, and not need to undergo a pre-polishing treatment or break-in, thereby reducing polishing system down-time.

The polishing surface 26 should be provided with the desired surface roughness on a “fresh” polishing pad, i.e., a pad that has not been used in a polishing operation. In general, a “fresh” polishing surface can be distinguished by one or more of the following features: grooves, if present, match the thickness specification provided by the supplier, abrasives particles are not embedded in the polishing surface, and the surface roughness is substantially uniform across the entire polishing pad.

In general, the polishing pad can be formed as follows. A polishing layer is formed by a molding or extrusion process. The polishing layer may be larger than the desired final pad shape and may be cut to a desired size and/or shape. For example, the polishing layer can be formed as a continuous sheet, e.g., by extrusion, onto a conveyor belt system, and then cut, e.g., stamped, into circular pads. Alternatively, the polishing layer may be formed in the desired final pad shape. For example, the polishing layer could be formed by injection molding, e.g., into a circular mold.

The polishing layer is subjected to a first grinding process which grinds the polishing layer to a rough thickness near the target thickness.

The polishing is then subjected to a second grinding process, typically of finer grit than the first grinding process, that grinds the polishing layer to a final thickness that is about equal to the target thickness. In this second grinding process, the grit size during grinding can be selected to provide the polishing surface with the desired surface roughness. For example, the second grinding process can be performed with 100 grit material. It should be noted that this grinding is performed at a dedicated grinding machine, not at the polishing machine that would be used to polishing substrates.

A backing layer may be secured to the polishing layer, e.g., using an adhesive, before the first grinding process, between the first and second grinding processes, or after the second grinding process.

The completed polishing pad with the desired surface roughness can be packaged, e.g., placed in a plastic covering which is then sealed, before shipment to the customer.

A number of embodiments of the invention have been described. Nevertheless, it will be understood that various modifications may be made without departing from the spirit and scope of the invention. For example, in some implementations, it may be possible to omit the first grinding step. Accordingly, other embodiments are within the scope of the following claims.

What is claimed is:

1. A polishing pad, comprising:
a polishing layer having a polishing surface with a surface roughness between about 200 and 300 microinches.

2. The polishing pad of claim 1, wherein the polishing surface has a surface roughness between about 250 and 300 microinches.

3. The polishing pad of claim 1, further comprising a backing layer on a side of the polishing layer opposite the polishing surface.

4. The polishing pad of claim 1, wherein the polishing layer comprises polyurethane with voids.

5. The polishing pad of claim 1, wherein the polishing surface is a fresh surface.

6. A method of making a polishing pad, comprising:
forming a polishing layer by extrusion or molding; and
grinding a polishing surface of the polishing layer to a surface roughness between about 200 and 300 microinches.

7. The method of claim 6, wherein grinding the polishing surface comprises grinding the polishing surface to a surface roughness between about 250 and 300 microinches.

8. The method of claim 6, further comprising attaching a backing layer to a side of the polishing layer opposite the polishing surface.

9. The method of claim 8, wherein the backing layer is attached to the polishing layer after the grinding step.

10. The method of claim 6, wherein the polishing layer comprises polyurethane with voids.

11. The method of claim 6, wherein the grinding step is performed at a machine other than a polishing machine used for polishing substrates.

12. The method of claim 6, further comprising using the polishing pad to polish a substrate after the grinding step.

13. The method of claim 6, wherein grinding the polishing surface includes a first grinding step and second grinding step with a finer grit than the first grinding step.

14. The method of claim 6, wherein forming the polishing layer comprising forming a polishing layer and cut the polishing layer to a desired shape.

15. The method of claim 6, wherein forming the polishing layer comprises forming the polishing layer as a sheet on a conveyor belt.

16. The method of claim 6, wherein forming the polishing layer comprises injection molding.
